(19) United States
(12) Patent Application Publication
(10) Pub. No.: US 2026/0233393 A1
(43) Pub. Date: Aug. 13, 2026

(54) INFORMATION PROCESSING DEVICE, INFORMATION PROCESSING METHOD, AND INFORMATION PROCESSING PROGRAM

(71) Applicant: OMRON CORPORATION, Kyoto (JP)

(72) Inventors: Masafumi ENDO, Tokyo (JP); Ryo YONETANI, Tokyo (JP); Tatsunori TANIAI, Tokyo (JP)

(73) Assignee: OMRON CORPORATION, Kyoto (JP)

(21) Appl. No.: 19/154,119

(22) PCT Filed: Jan. 31, 2024
(86) PCT No.: PCT/JP2024/003170

§ 371 Date: Aug. 6, 2025

(30) Foreign Application Priority Data
Feb. 28, 2023 (JP) 2023-030489
May 29, 2023 (JP) 2023-088196

(51) Int. Cl. B25J 9/16; G06V 10/764

(52) U.S. Cl. CPC B25J 9/1664; B25J 9/1697; G06V 10/764

(57) ABSTRACT

There is provided an information processing device including: a class probability calculation unit that calculates, for each position of a target range, a probability distribution representing a probability of each class indicating a type of a region or a space from bird's-eye view data observed from a position at which the target range is overlooked; and an index distribution calculation unit that calculates, for each position of the target range, a probability distribution of an index on a basis of the probability distribution and the index indicating preference of a moving object for each class as a movement region or a movement space.

### TECHNICAL FIELD

The present disclosure relates to an information processing device, an information processing method, and an information processing program.

### BACKGROUND ART

In the related art, there is known a technique of definitively determining a terrain type (the most likely one) for each position in an environment by using a terrain classification model, estimating a risk by using a risk estimation model associated with the terrain type, and performing risk-considered path planning (for example, A* search) on the basis of the risk (for example, refer to C. Cunningham et al., “Locally-adaptive slip prediction for planetary rovers using gaussian processes,” in Proceedings of International Conference on Robotics and Automation, 2017, pp. 5487-5494).

### SUMMARY OF INVENTION

### Technical Problem

In the related art, a terrain type is determined for each position in an environment by using a terrain classification model, and a risk is estimated by using a risk estimation model associated with the terrain type. Therefore, it is not possible to deal with an error in terrain classification.

An object of the present disclosure is to estimate a probability distribution of preference as a movement region or a movement space, the preference being an index for estimating a risk for each position of a target range, in consideration of errors in classification of a type of a region or a space.

In addition, an object of the present disclosure is to generate a map of preference as a movement region or a movement space and plan a movement path, the preference being an index for estimating a risk for each position of a target range, in consideration of a certainty of classification by a classification model which classifies a class indicating a type of a region or a space.

### Solution to Problem

In order to achieve the above object, according to a first aspect, there is provided an information processing device including: a class probability calculation unit that calculates, for each position of a target range, a probability distribution representing a probability of each class indicating a type of a region or a space from bird's-eye view data observed from a position at which the target range is overlooked; and an index distribution calculation unit that calculates, for each position of the target range, a probability distribution of an index on a basis of the probability distribution and the index indicating preference of a moving object for each class as a movement region or a movement space.

According to a second aspect, in the information processing device according to the first aspect, the information processing device may further include: a map generation unit that generates a map representing the index at each position of the target range on a basis of the probability distribution of the index at each position of the target range; and a path planning unit that plans a movement path of the moving object on a basis of the map.

According to a third aspect, there is provided an information processing device including: a map generation unit that estimates, for each position of a target range, a certainty of classification by using a certainty estimation model for estimating the certainty of classification by a classification model which classifies a class indicating a type of a region or a space, from bird's-eye view data observed from a position at which the target range is overlooked, and generates a map representing an index indicating preference of a moving object for each position of the target range as a movement region or a movement space on a basis of the certainty; and a path planning unit that plans a movement path of the moving object on a basis of the map.

According to a fourth aspect, in the information processing device according to the third aspect, the information processing device further includes: a class probability calculation unit that calculates, for each position of the target range, from the bird's-eye view data, a probability distribution representing a probability of each class indicating a type of a region or a space; and an index distribution calculation unit that calculates, for each position of the target range, a probability distribution of an index on a basis of the probability distribution and the index indicating preference of the moving object for each class as a movement region or a movement space, in which the map generation unit generates the map on a basis of the probability distribution of the index at each position of the target range and the certainty at each position of the target range.

According to a fifth aspect, in the information processing device according to any one of the first to fourth aspects, the moving object is a vehicle, a robot, a character in a game, or a flying object.

According to a sixth aspect, there is provided an information processing method causing a computer to execute a process including: calculating, for each position of a target range, a probability distribution representing a probability of each class indicating a type of a region or a space from bird's-eye view data observed from a position at which the target range is overlooked; and calculating, for each position of the target range, a probability distribution of an index on a basis of the probability distribution and the index indicating preference of a moving object for each class as a movement region or a movement space.

According to a seventh aspect, there is provided an information processing method causing a computer to execute a process including: estimating, for each position of a target range, a certainty of classification by using a certainty estimation model for estimating the certainty of classification by a classification model which classifies a class indicating a type of a region or a space, from bird's-eye view data observed from a position at which the target range is overlooked, and generating a map representing an index indicating preference of a moving object for each position of the target range as a movement region or a movement space on a basis of the certainty; and planning a movement path of the moving object on a basis of the map.

According to an eighth aspect, there is provided an information processing program causing a computer to function as: a class probability calculation unit that calculates, for each position of a target range, a probability distribution representing a probability of each class indicating a type of a region or a space from bird's-eye view data observed from a position at which the target range is overlooked; and an index distribution calculation unit that calculates, for each position of the target range, a probability distribution of an index on a basis of the probability distribution and the index indicating preference of a moving object for each class as a movement region or a movement space.

According to a ninth aspect, there is provided an information processing program causing a computer to function as: a map generation unit that estimates, for each position of a target range, a certainty of classification by using a certainty estimation model for estimating the certainty of classification by a classification model which classifies a class indicating a type of a region or a space, from bird's-eye view data observed from a position at which the target range is overlooked, and generates a map representing an index indicating preference of a moving object for each position of the target range as a movement region or a movement space on a basis of the certainty; and a path planning unit that plans a movement path of the moving object on a basis of the map.

### Advantageous Effects of Invention

According to the information processing device, the information processing method, and the information processing program of the present disclosure, it is possible to estimate a probability distribution of preference as a movement region or a movement space, the preference being an index for estimating a risk for each position of a target range, in consideration of errors in classification of a type of a region or a space.

According to the information processing device, the information processing method, and the information processing program of the present disclosure, it is possible to generate a map of preference as a movement region or a movement space and plan a movement path, the preference being an index for estimating a risk for each position of a target range, in consideration of a certainty of classification by a classification model which classifies a class indicating a type of a region or a space.

### BRIEF DESCRIPTION OF DRAWINGS

FIG. 1 is a diagram for explaining the present embodiment.

FIG. 2 is a diagram for explaining the present embodiment.

FIG. 3 is a diagram for explaining the present embodiment.

FIG. 4 is a diagram for explaining the present embodiment.

FIG. 5 is a block diagram illustrating a schematic configuration of an information processing system according to a first embodiment.

FIG. 6 is a block diagram illustrating a hardware configuration of an information processing device according to the present embodiment.

FIG. 7 is a flowchart illustrating a flow of path planning processing according to the first embodiment.

FIG. 8 is a block diagram illustrating a schematic configuration of an information processing system according to a second embodiment.

FIG. 9 is a flowchart illustrating a flow of path planning processing according to the second embodiment.

FIG. 10 is a diagram for explaining the present embodiment.

FIG. 11 is a diagram for explaining the present embodiment.

FIG. 12 is a diagram for explaining the present embodiment.

FIG. 13 is a diagram for explaining the present embodiment.

FIG. 14 is a diagram for explaining the present embodiment.

FIG. 15 is a diagram for explaining the present embodiment.

FIG. 16 is a diagram for explaining the present embodiment.

### DESCRIPTION OF EMBODIMENTS

Hereinafter, an example of an embodiment of the present disclosure will be described with reference to the drawings. In the present embodiment, a case in which an information processing device according to the present disclosure plans a movement path of a moving object will be described as an example. In the drawings, the same or equivalent components and portions are denoted by the same reference numerals. In addition, dimensions and ratios in the drawings are exaggerated for convenience of description, and may be different from actual ratios.

### OUTLINE

It is considered a situation where a terrain classification model and a risk estimation model are given. The terrain classification model is a machine learning model that can identify “place/terrain type” (for example, gravel, asphalt, puddle, wall, and the like) for each position in an environment on the basis of terrain information obtained as an image from a drone or a surveillance camera. The risk estimation model is a machine learning model that estimates a risk (for example, rollover, getting stuck, or the like due to a slip of a wheel) in movement of an AMR according to the terrain type. In the embodiment of the present disclosure, a risk map of the entire environment obtained by imaging of the camera is estimated by using these models, and “risk-considered path planning” is realized such that a moving object reaches a goal without passing through high-risk regions as much as possible.

In particular, in the embodiment of the present disclosure, even in a situation where an error is included in terrain classification or estimation of a risk estimation model due to ambiguousness of input or lack of data, it is possible to plan a low-risk path while clearly considering the error.

Specifically, (1) a classification result is expressed as a probability distribution in a form of “what is the percentage probability that each position in the environment has a specific terrain type?” by using the terrain classification model, and (2) a probability distribution of a preference index is first obtained by adding estimation results of all possible terrain types obtained by the risk estimation model in a form of “when a probability of a terrain A is 70% and a ground slope angle is XXX degrees, movement at the position has a preference index with a mean VV and a deviation SS”, and a risk is calculated in a form of calculating a risk from the “probability distribution of the preference index on the basis of a certain criterion (for example, a conditional value at risk)” (in the case of the above-described technique in the related art, a risk is calculated in consideration of only the most probable terrain A).

In other words, it is possible to perform risk estimation in which a risk of “in a case in which the terrain classification is incorrect” is clearly considered. In fact, it has been confirmed that, in a simulation task of simulating planetary exploration, as compared with a case in which path planning is successfully followed with a probability of only approximately 10% due to an error of a terrain classification model, path planning can be successfully followed with a probability of 95% by using a method of the embodiment of the present disclosure. That is, by using the method of the embodiment of the present disclosure, it is possible to significantly reduce a case in which “an AMR cannot follow a planned path”.

It is expected that risk estimation will contribute to a general situation in which navigation of an AMR needs to be performed on the basis of clues from conditions of scenes obtained by aerial photography, such as planetary exploration and a disaster rescue. In these cases, it is not possible to construct obstacle structures and risk factors in the environment as a map in advance, and as a result, it is necessary to determine a risk only from aerial photography information and sensor information of the robot at that time. Since the risk factors in the environment are determined on the basis of complex relationships such as geometric structures of the terrain and physical properties of the ground, it is difficult to estimate a level of the risk by simulations or theoretical models in the world, and thus, utilizing machine learning is a promising approach. On the other hand, it is inevitable that an error is included in an estimation result of a machine learning model, such as a case in which the aerial photography information has low resolution or a case in which data is simply insufficient. A main advantage of the embodiment of the present disclosure is that path planning can be performed even in a case in which such an incomplete machine learning model is utilized.

Machine learning (ML) plays an important role in estimating a passability of an autonomous rover operation on a deformable terrain, but has a problem of inevitable prediction errors. In particular, in an uneven terrain where the geological characteristics vary from location to location, the passability on the uneven terrain is likely to be erroneously predicted, and the erroneous prediction results in an increase of an irrecoverable risk that the rover enters into a wheel slip state or a stuck state. In this work, a new path planning algorithm that explicitly explains such erroneous predictions is proposed. The main idea is to probabilistically combine characteristic ML models into a single distribution for terrain type classification and slip prediction. Thereby, a multimodal slip distribution representing an uneven terrain is obtained, and a statistical risk estimation can be further applied to derive a risk-aware traverse cost for path planning. Extensive simulation experiments have demonstrated that the proposed method can generate more feasible paths on an uneven terrain as compared to existing methods.

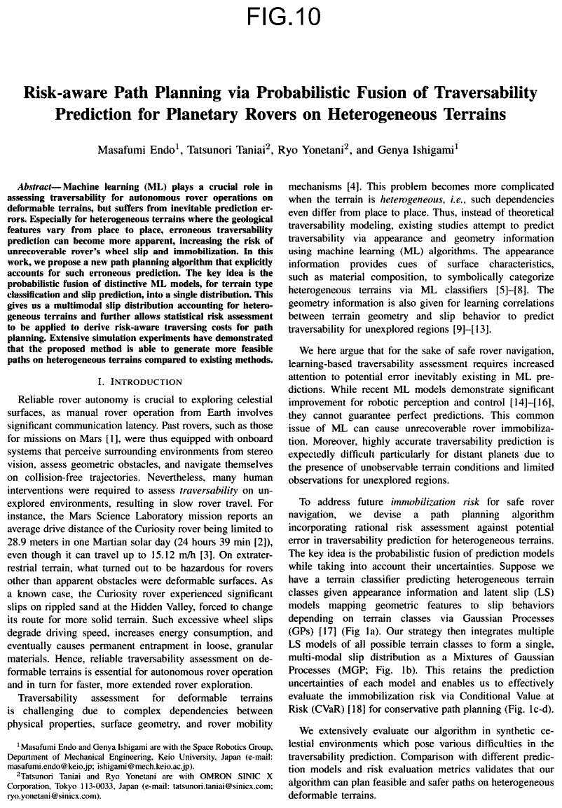

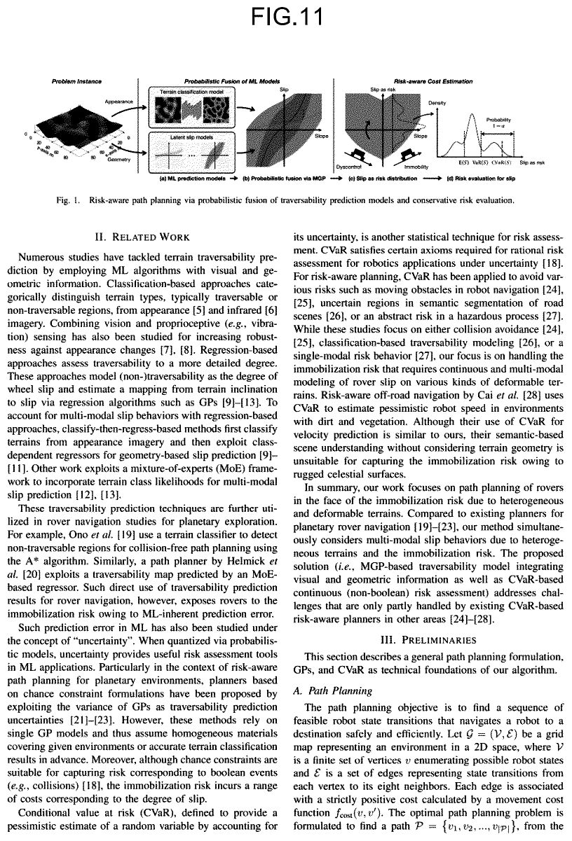

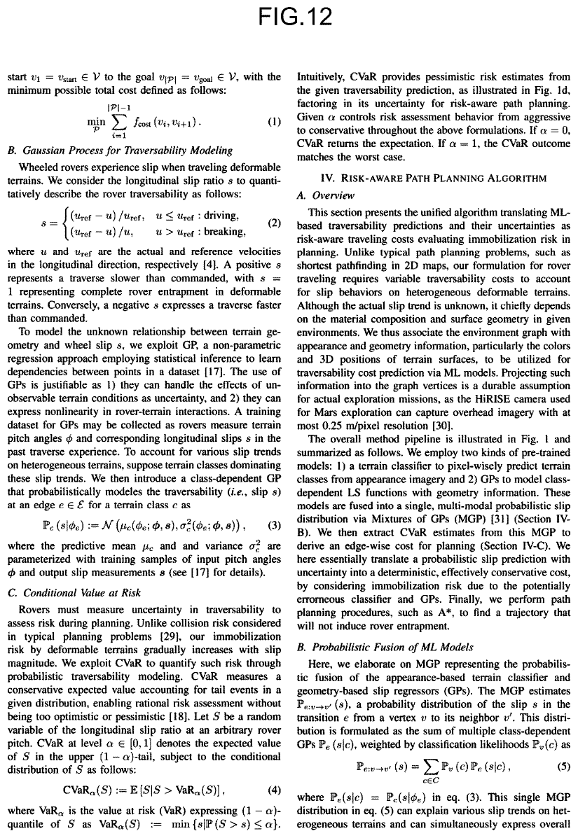

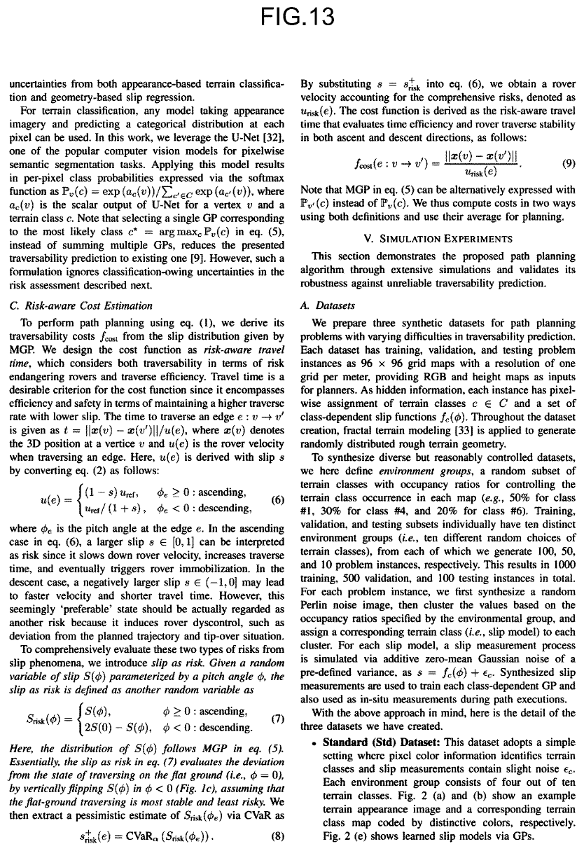

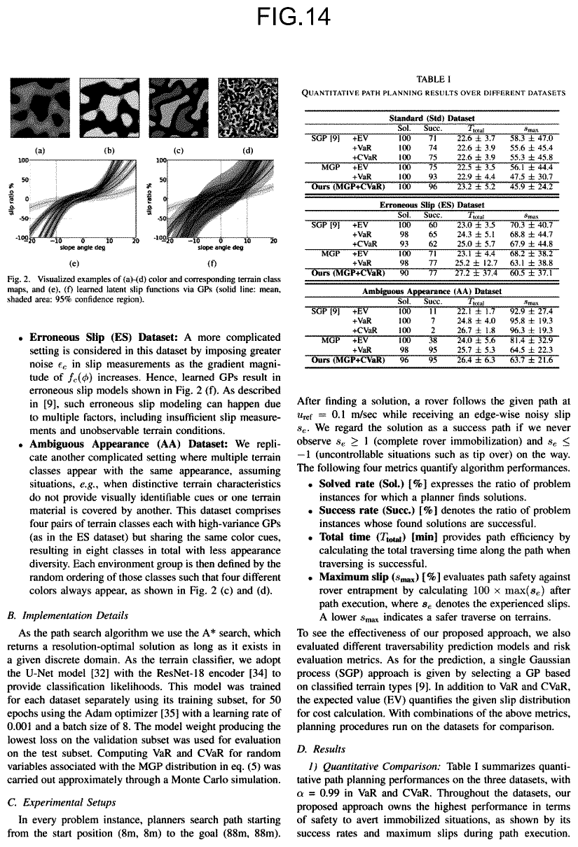

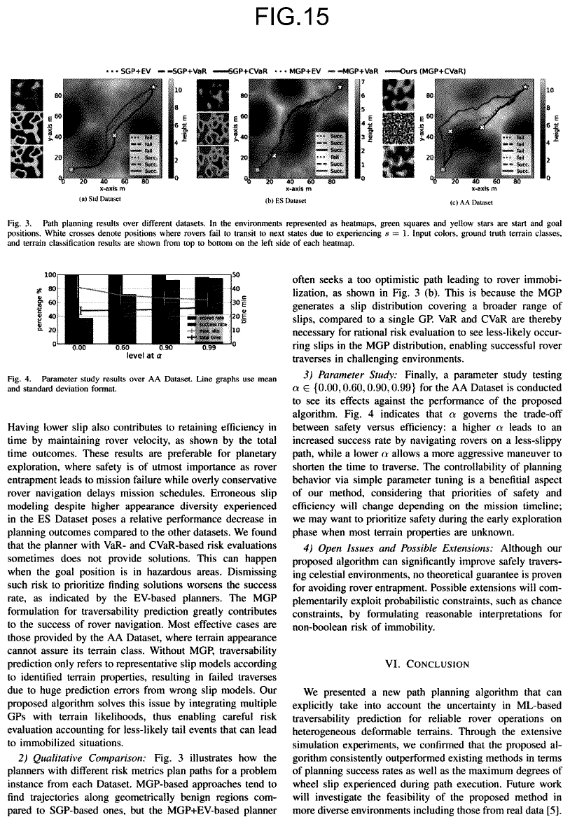

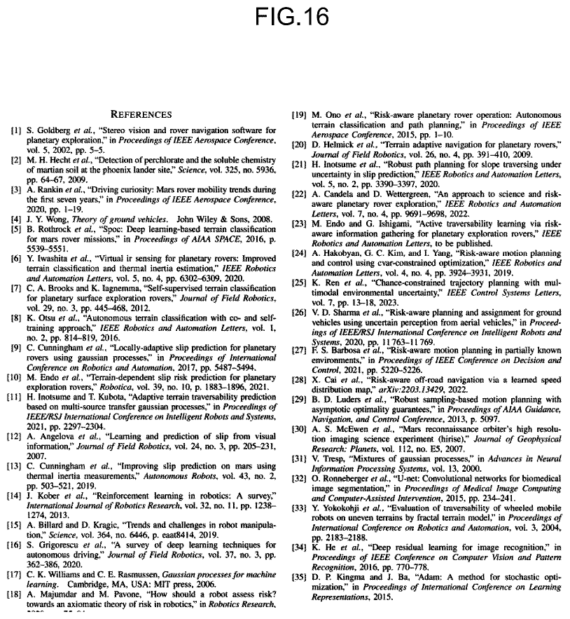

Note that, in the following description, numbers in [ ] represent reference documents shown in FIG. 10 to FIG. 16.

### I. INTRODUCTION

Since a manual operation of a rover from the Earth involves a significant communication delay, reliable autonomy of a rover is essential for exploring a surface of a celestial body. Thus, a past rover such as the Mars Mission as described in [1] were provided with an onboard system that recognizes the surrounding environment from stereo vision, estimates geometric obstacles, and allows the rover to move on a trajectory without collision. Nevertheless, many human interventions were required to estimate the passability on a terrain in an unexplored environment, and this results in slower movement of the rover. For example, a mission of the Mars Science Laboratory reported that an average movement distance of the Curiosity rover is limited to 28.9 meters per day (24 hours and 39 minutes, [2]) on Mars, despite being able to move at a speed of up to 15.12 meters per hour, as described in [3]. In an extraterrestrial Restoria terrain, it was proved that a deformable surface is dangerous for the rover besides obvious obstacles. As a known case, the Curiosity rover experienced significant slips on rippling sand of the Hidden Valley, and was forced to change the path to a harder terrain. Such excessive wheel slip reduces a movement speed, increases energy consumption, and finally causes the rover to be permanently confined in loose particulate matter. Therefore, reliable estimation of the passability on a deformable terrain is essential for an autonomous operation of the rover, and is also essential for faster and expanded exploration of the rover.

It is difficult to estimate the passability on a deformable terrain due to a complex dependency relationship among physical properties, a shape of a surface, and a mobility mechanism of the rover as described in [4]. This problem becomes more complex in a case in which the terrain is uneven, that is, in a case in which the dependency relationships are different for each location. For this reason, instead of theoretical passability modeling, existing research attempts to predict the passability on the basis of appearance information and geometry information by using a machine learning (ML) algorithm. The appearance information provides a clue to a surface property such as material composition, and is used to symbolically classify terrains having different types through ML classifiers as described in [5] to [8]. The geometry information is also provided for learning of a correlation relationship between terrain geometry and slip behavior to predict the passability in an unexplored region, as described in [9] to [13].

Here, for safe navigation of the rover, it is claimed that the learning-based passability estimation needs to pay attention to latent errors which inevitably exist in the ML prediction. Recent ML models have shown significant improvements in recognition and control for a robot, as described in [14] to [16], but cannot guarantee perfect prediction. This general problem of the ML may cause irrecoverable immobilization of the rover. Further, particularly in distant planets, there are terrain conditions that cannot be observed, and observation of undeveloped regions is limited. As a result, it is expected that it is difficult to accurately predict the passability. In order to handle a future immobilization risk for safe navigation of the rover, a path planning algorithm that incorporates rational estimation of a risk due to latent errors in predicting the passability on an uneven terrain is devised.

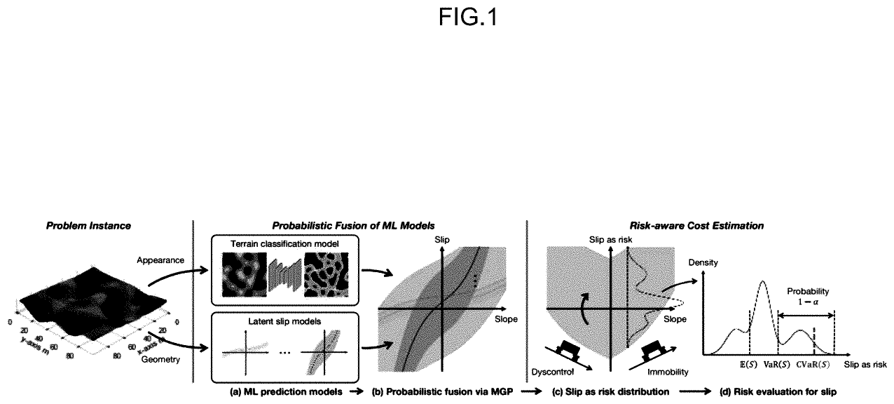

The main idea is to probabilistically combine prediction models in consideration of uncertainty. In a case in which there is given a latent slip (LS) model that maps a geometric feature to a slip operation according to appearance information and a terrain class through a Gaussian process (GP) as described in [17] (FIG. 1(a)), it is assumed that there is a terrain classifier that predicts terrain classes having different types. Next, a strategy of the present disclosure is to create a single multimodal slip distribution as a mixture of Gaussian processes (MGP, refer to FIG. 1(b)) by integrating a plurality of LS models for all possible terrain classes. Thereby, uncertainty of prediction of each model is maintained, and an immobilization risk can be effectively estimated through a conditional value at risk (CVaR) for conservative path planning as described in [18] (FIG. 1(c) and FIG. 1(d)).

The algorithm is extensively estimated in combined celestial environments in which there are various difficulties in predicting the passability. By comparing various prediction models with a risk estimation indicator, it is verified that the algorithm can plan a feasible and safe path on a deformable terrain having a different type.

### II. RELATED ART

Numerous studies have addressed prediction of the passability on a terrain by adopting an ML algorithm with visual information and geometric information. In classification-based approach, terrain types (usually, a passable region and an impassable region) are classified from appearance [5] and infrared images [6]. A technique of combining visual sensing and proprioceptive (such as vibration) sensing to increase robustness to changes in appearance has also been studied as described in [7] and [8]. In regression-based approach, the passability is estimated in more detail.

In these approaches, the passability (impassability) is modeled as a degree of slip of wheels, and mapping from a terrain slope to the slip is estimated through a regression algorithm such as a GP, as described in [9] to [13]. For representation of a multimodal slip operation in the regression-based approach, a post-classification regression-based method first classifies terrains from appearance images, and then utilizes a class-dependent regressor for geometry-based slip prediction, as described in [9] to [11]. In other studies, mixture-of-experts (MoE) frameworks are utilized to incorporate likelihood of terrain classes for multimodal slip prediction, as described in [12] and [13].

These techniques of predicting the passability are also utilized in rover navigation studies for planetary exploration. For example, Ono et al. [19] use a terrain classifier to detect impassable regions for collision-free path planning using the A* algorithm. Similarly, a path planer [20] by Helmic et al. utilizes a passability map predicted by an MoE-based regressor. However, in a case in which a passability prediction result is directly used for navigation of a rover in this way, the rover is at a risk of immobilization due to prediction errors inherent in ML.

Such ML prediction errors have also been studied under the concept of “uncertainty”. In a case in which quantization is performed through a probabilistic model, uncertainty provides a risk estimation tool that is useful in ML applications. In particular, in the context of path planning in consideration of risks in the planetary environment, planners based on chance-constrained formulation have been proposed in which a variance of GPs is utilized as uncertainty in prediction of the passability, as described in [21] to [23]. However, since these methods rely on a single GP model, it is assumed in advance that homogeneous materials covering a specific environment or accurate terrain classification results are used. Further, although the chance-constrained formulation is suitable for capturing a risk corresponding to a Boolean event (such as a collision) [18], an immobilization risk involves various costs corresponding to the degree of slip.

The conditional value at risk (CVaR) that is pessimistic estimation of a random variable representing uncertainty is another statistical method for risk estimation. The CVaR satisfies a specific principle required for rational risk estimation of robotics applications under uncertainty, as described in [18]. In a risk-aware plan, the CVaR is applied to avoid various risks such as moving obstacles in robot navigation as described in [24] and [25], uncertain regions in semantic segmentation of road scenes as described in [26], or abstractive risks in dangerous processes as described in [27]. Although these studies focus on either collision avoidance as described in [24] and [25], classification-based passability modeling as described in [26], or single modal risk behavior as described in [27], the present disclosure focuses on immobilization risk processing requiring a plurality of continuous operations and modal modeling of rover slip on deformable terrains having various different types. Risk-aware off-load navigation [28] by Tsai et al. uses the CVaR to estimate a pessimistic robot speed in an environment with soil and vegetation. Although this technique is similar to the present disclosure in that the CVaR is used for speed prediction, a conception of a semantic-based scene that does not consider a shape of a terrain is not suitable for recognition of an immobilization risk due to a rough celestial surface.

In summary, the technique of the present disclosure focuses on path planning of a rover that faces an immobilization risk due to an uneven and deformable terrain. As compared to the existing planners for planetary rover navigation as described in [19] to [23], the method of the present disclosure simultaneously considers an uneven terrain and a multi-modal slip operation due to an immobilization risk. The proposed solution (that is, an MGP-based passability model that integrates visual information and geometric information, and a CVaR-based continuous (non-Boolean) risk estimation) addresses a problem that an immobilization risk is only partially handled by existing CVaR-based risk-aware planners in areas [24] to [28].

### III. PRELIMINARY

In this section, general path planning formulation, GP, and CVaR will be described as a technical basis of the algorithm.

### <A. Path Planning>

The purpose of the path planning is to find a series of feasible robot state transitions that safely and efficiently navigate the robot to a destination. It is assumed that G=(V, E) is a grid map representing a 2D space environment. Here, V is a finite set of vertices v listing possible robot states, and E is a set of edges representing state transitions from each vertex to eight adjacent vertices of the vertex. Each edge headed from a vertex v to another vertex v′ is associated with a strictly positive cost calculated by a movement cost function f_{cost}(v, v′). An optimum path planning problem is formulated to find a path P={v₁, v₂, . . . , vₚ}. From a start v₁=vₛₜₐᵣₜ∈V to a goal v_{|P|}=v_{goal}∈V, the possible minimum total cost is defined as follows.

$${min}_{𝒫} {\sum }_{i = 1}^{\vert 𝒫 \vert - 1} {f}_{cost} ( {v}_{i} , {v}_{i + 1} ) . \qquad ( 1 )$$

### <B. Gaussian Process of Passability Modeling>

A wheeled rover experiences slip when moving on a deformable terrain. In consideration of a slip ratio s in a longitudinal direction, the passability of the rover will be quantitatively described as follows.

$$s = \{ \begin{matrix}( {u}_{ref} - u ) / {u}_{ref} , & u \leq {u}_{ref} : driving , \\ ( {u}_{ref} - u ) / u , & u > {u}_{ref} : braking ,\end{matrix} \qquad ( 2 )$$

Here, u and u_{ref} are respectively an actual speed and a reference speed in the longitudinal direction as described in [4]. A positive s represents a traverse slower than a command, and s=1 represents a complete confinement of the rover on the deformable terrain. Conversely, a negative s represents a traverse faster than a command.

In order to model an unknown relationship between a terrain shape and wheel slip, the present disclosure utilizes a GP, which is a non-parametric regression approach that uses statistical inference to train a dependency relationship between points in a data set [17]. The use of the GP is justified because 1) the GP can treat an influence of an unobservable terrain condition as uncertainty and 2) the GP can represent nonlinearity of interactions between the rover and the terrain. A training data set of the GP is collected when the rover measures a pitch angle of the terrain and the corresponding slip s in the longitudinal direction from past traverse experience. In order to represent various slip tendencies on an uneven terrain, it is assumed that there is a terrain class that controls these slip tendencies. Next, a class-dependent GP that probabilistically models the passability (that is, the slip s) at an edge e∈E of the terrain class c is introduced.

$${ℙ}_{c} ( s \vert {ϕ}_{c} ) := 𝒩 ( {μ}_{c} ( {ϕ}_{c} ; ϕ , s ) , {σ}_{c}^{2} ( {ϕ}_{c} ; ϕ , s ) ) , \qquad ( 3 )$$

Here, a predicted mean μ_{c} and a variance σ²_{c} are parameterized with a training sample of an input pitch angle and an output slip measurement value s (refer to [17] for details).

### <C. Conditional Value at Risk>

The rover needs to measure uncertainty of the passability in order to estimate a risk during planning. Unlike a collision risk which is considered in a typical planning problem as described in [29], an immobilization risk due to a deformable terrain gradually increases depending on a degree of the slip. The CVaR is utilized to quantify such a risk through probabilistic passability modeling. The CVaR measures a conservative expectation value representing a tail event of a specific distribution, and allows a rational risk estimation without becoming too optimistic or pessimistic as described in [18]. It is assumed that S is a random variable of the slip ratio in the longitudinal direction at an arbitrary rover pitch. The CVaR at a level α∈[0, 1] indicates an expected value of S for an upper (1−α) tail that follows such a conditional distribution of S.

$${CVaR}_{α} ( 𝒮 ) := 𝔼 [ S \vert S > {VaR}_{α} ( S ) ] , \qquad ( 4 )$$

Here, VaR_{α} is a value at risk (VaR), and a quantile of (1−α)−S is represented as the following expression.

$${VaR}_{α} ( S ) := min \{ s \vert ℙ ( S > s ) \leq α \} .$$

Intuitively, the CVaR provides a pessimistic risk estimation value from designated passability prediction, and considers the uncertainty of the risk-aware pat planning, as illustrated in FIG. 1(d). The given a controls a risk estimation behavior from aggressive to conservative through the above formulation. In a case of α=0, the CVaR returns an expected value. In a case of α=1, a result of the CVaR coincides with the worst case.

### IV. PATH PLANNING ALGORITHM CONSIDERING RISK

### <A. Overview>

In this section, as a risk-aware movement cost for estimating an immobilization risk in the plan, a unified algorithm for converting the ML-based passability prediction and the uncertainty of the prediction will be described. Unlike typical path planning problems, such as shortest path searching on 2D maps, formulation related to movement of a rover requires a variable passability cost to represent a slip operation on a deformable terrain having a different type. An actual slip tendency is not known, but mainly depends on the material composition and the surface shape in the specific environment. Therefore, an environment graph is associated with the appearance information and the geometry information, in particular, a color of the terrain surface and a 3D position of the terrain, and is used for cost prediction of the passability through the ML model.

Since the HiRISE camera used for the Mars exploration can capture overhead images at resolution up to 0.25 m/pixel, projecting such information onto the vertices of the graph is a permanent assumption for an actual exploration mission [30]. An overall method pipeline is shown in FIG. 1, and is summarized below. Two types of pre-trained models are used. The first model is a terrain classifier that predicts a terrain class in units of pixels from an appearance image, and the second model is a GP that models a class-dependent LS function by using the geometry information. These models are combined into a single multi-modal probability slip distribution through mixtures of GPs (MGP) [31] (section IV-B).

Next, a CVaR estimation value is extracted from the MGP to derive a cost in units of edges of the plan (section IV-C). Here, the probabilistic slip prediction with uncertainty is effectively converted into a cost that is deterministic and conservative by considering the immobilization risk due to the classifier and the GP having latent errors. Finally, a path planning procedure such as A* is performed to find a trajectory that does not cause confinement of the rover.

### <B. Probabilistic Combination of ML Models>

The MGP representing a probabilistic combination of an appearance-based terrain classifier and a geometry-based slip regressor (GP) will now be described in detail. The MGP estimates a probability distribution P_{e: v→v′}(s) of the slip s at an edge e from a vertex v to an adjacent vertex v′. This distribution is formulated as a sum of a plurality of class-dependent GPs.

$${ℙ}_{e : v \to {v}^{′}} ( 𝓈 ) = {\sum }_{c ∈ C} {ℙ}_{v} ( c ) {ℙ}_{e} ( 𝓈 \vert c ) , \qquad ( 5 )$$

The probability distribution is weighted by classification likelihood Pᵥ(c).

Here, in the expression (3), P_{c}(s|c) is represented by the following expression.

$${ℙ}_{e} ( s \vert c ) = {ℙ}_{c} ( 𝓈 \vert {ϕ}_{e} )$$

This single MGP distribution in the expression (5) explains a tendency of various slips on the terrains having different types, and can simultaneously represent the overall uncertainty. The distribution of the single MGP equation in the expression (5) can explain a tendency of various slips having different types, and can simultaneously represent the overall uncertainty from both terrain classification based on the terrain information and the appearance information and geometry-based slip regression.

In the terrain classification, any model that obtains an appearance image and predicts a category distribution at each pixel may be used. This work utilizes U-Net [32] which is one of common computer vision models for pixel-by-pixel semantic segmentation tasks. In a case in which this model is applied, a class probability per pixel is obtained by the following expression through a softmax function.

$${ℙ}_{v} ( c ) = exp ( {a}_{c} ( v ) ) / {\sum }_{{c}^{′} ∈ C} exp ( {a}_{{C}^{′}} ( v ) ) ,$$

Here, a_{c}(v) is a scalar output of the U-net for the vertex v and the terrain class c. Note that, instead of summing the plurality of GPs, a single GP corresponding to a class c* having a highest passability in the following expression may be selected.

$${C}^{★} = arg {max}_{c} {ℙ}_{v} ( c )$$

In a case of selecting a single GP corresponding to the class c*, the presented passability prediction is reduced to an existing prediction as described in [9]. Here, in such a formulation, uncertainty due to classification in the risk estimation to be described below is ignored.

### <C. Cost Estimation Considering Risk>

In order to perform path planning using the expression (1), a passability cost f_{cost} is derived from the slip distribution given by the MGP. A cost function is designed as a risk-aware movement time, and the passability is considered in terms of both the risk of the rover and movement efficiency. The movement time is a desirable criterion for the cost function because the movement time includes concepts of efficiency and safety in terms of maintaining a high traverse.

A time required to traverse the edge e of v→v′ is given as the following expression.

t=∥x(v)−x(v′)∥/u(e),

Here, x(v) is a 3D position at the vertex v, and u(e) is a speed when traversing the edge. Here, u(e) is obtained by converting the expression (2) using the slip s as follows.

$$u ( e ) = \{ \begin{matrix}( 1 - s ) {u}_{ref} , & {ϕ}_{e} \geq 0 : ascending , \\ {u}_{ref} / ( 1 + s ) , & {ϕ}_{e} < 0 : descending ,\end{matrix} \qquad ( 6 )$$

Here, Φₑ is a pitch angle at the edge e. In the expression (6), in the case of ascending, a large slip s∈[0, 1] can be interpreted as a risk, since the large slip s reduces the speed of the rover, increases the traverse time, and finally causes immobilization of the rover. In the case of descending, as the slip sε(−1, 0] increases in a negative direction, the speed may become faster, and the movement time may become shorter. However, since this may cause rover uncontrollability such as a situation where the rover deviates from the planned trajectory and tumbles, this seemingly “preferred” state should actually be considered as another risk.

In order to comprehensively estimate the risk due to these two types of slip phenomena, slip is introduced as a risk. In a case in which there is given a random variable of the slip S(φ) parameterized by the pitch angle φ, the slip as a risk is defined as another random variable as follows.

$${S}_{risk} ( ϕ ) = \{ \begin{matrix}S ( ϕ ) & ϕ \geq 0 : ascending , \\ 2 S ( 0 ) - S ( ϕ ) , & ϕ < 0 : descending .\end{matrix} \qquad ( 7 )$$

Here, the distribution of S(φ) follows the MGP in the expression (5). Essentially, assuming that traverse on level ground is most stable, the slip as a risk in the expression (7) estimates a deviation from the traverse state on level ground (that is, φ=0) by inverting S(φ) at φ<0 in a vertical direction (FIG. 1(c)). Thus, the lowest risk is obtained. Next, a pessimistic estimation value of Sᵣᵢₛₖ(φ_{w}) is extracted through the CVaR as follows.

$$\begin{matrix}{s}_{risk}^{+} ( e ) = {CVaR}_{α} ( {S}_{risk} ( {ϕ}_{e} ) ) . \\ s = {s}_{risk}^{+}\end{matrix} \qquad ( 8 )$$

By substituting the S into the expression (6), the rover speed representing a comprehensive risk is acquired. The comprehensive risk is denoted as uᵣᵢₛₖ(e). The cost function is derived as a risk-aware movement time for estimating the time efficiency and the traverse stability of the rover in both the ascending direction and the descending direction as follows.

$${f}_{cost} ( e : v \to {v}^{′} ) = \frac{‖ x ( v ) - x ( {v}^{′} ) ‖}{{u}_{risk} ( e )} . \qquad ( 9 )$$

Note that the MGP in the expression (5) can be rephrased as Pᵥ′(c) instead of Pᵥ(c). Therefore, both definitions are used to calculate costs in two ways, and an average of the costs is used for planning.

### V. SIMULATION EXPERIMENT

In this section, a path planning algorithm proposed through large-scale simulation is obtained, and robustness of the path planning algorithm against unreliable passability prediction is verified.

### <A. Data Sets>

Three combined data sets are prepared for the path planning problem with various difficulties in the passability prediction.

Each data set includes problem instances for training, verification, and test as a 96×96 grid map with a resolution of one grid per meter, and provides an RGB map and a height map as inputs of the planer. As hidden information, each instance includes a set of assignment of a terrain class c∈C per pixel and a class-dependent slip function f_{c}(φ). Throughout the creation of the data sets, fractal terrain modeling [33] is applied, and thus, terrain geometry that is randomly distributed and is rough is generated.

In order to combine various data sets that are rationally controlled, environment groups are defined here. The environment groups are random subsets of terrain classes which have an occupancy ratio to control generation of terrain classes on each map (for example, 50% for class #1, 30% for class #4, and 20% for class #6). The subsets for training, verification, and test individually include 10 different environment groups (that is, 10 different random selections of terrain class), and 100, 50, and 10 problem instances are generated from each of the subsets. Thereby, a total of 1000 training instances, 500 verification instances, and 100 test instances are generated. In consideration of the approach described above, the details of the created three data sets are provided as follows.

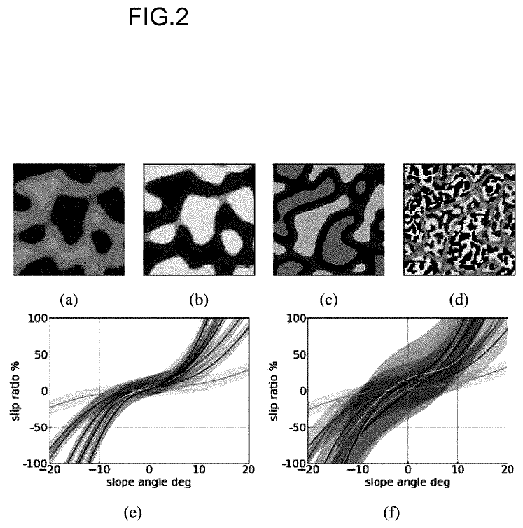

For each problem instance, random Perlin noise images are first combined, then values are clustered based on the occupancy ratio designated by the environment group, and a corresponding terrain class (that is, a slip model) is assigned to each cluster. For each slip model, a slip measurement process is simulated through an additional zero-mean Gaussian noise of a variance which is predefined, such as s=f_{c}(φ)+F_{c}. The combined slip measurement values are used to train GPs that depend on each class, and are also used as measurement values at the location during path execution.
Standard (Std) data set: This data set adopts a simple setup in which the terrain class is identified by the color information of the pixel and the slip measurement value includes a small amount of noise ε_{c}. Each environment group includes four terrain classes among ten terrain classes. FIG. 2(a) and FIG. 2(b) respectively illustrate an example of a terrain appearance image and a corresponding terrain class map coded with characteristic colors. FIG. 2(e) shows a slip model trained through the GP.
Erroneous Slip (ES) data set: In this data set, a more complex setup is considered in which a larger noise ε_{c} is imposed to the slip measurement as a level of the slope of f_{c}(φ) increases. Therefore, the trained GP becomes an erroneous slip model shown in FIG. 2(f). As described in [9], such erroneous slip modeling may be performed due to a plurality of factors, such as insufficient slip measurements or unobservable terrain conditions.
Ambiguous Appearance (AA) data set: Another complex setup in which a plurality of terrain classes are displayed with the same appearance is replicated. For example, situations, such as a case in which a unique terrain property does not provide a visually-identifiable cue or a case in which one terrain material is covered by another material, are assumed. This data set includes four sets of terrain classes each of which has a high-variance GP (as in the ES data set) and shares the same color cues, and thus, a total of eight classes having a lower variety in appearance are obtained. Next, each environment group is defined by random ordering of these classes such that four different colors are always displayed as shown in FIG. 2(c) and FIG. 2(d).

### <B. Details of Implementation>

As a path search algorithm, A* search is used. This algorithm returns a solution with optimum resolution as long as the algorithm exists in a specific discrete domain. As the terrain classifiers, a U-Net model as described in [32] and a ResNet-18 encoder as described in [34] are adopted to provide a classification possibility. This model was individually trained for each data set by using training subsets for 50 epochs with an Adam optimizer as described in [35] at a learning rate of 0.001 and a batch size of 8. The weight of the model that generates a minimum loss in the verification subset were used in the estimation test subset. VaR and CVaR of the random variable associated with the MGP distribution in the expression (5) are calculated. The simulation was approximately performed by Monte Carlo simulation.

### <C. Setup for Experiment>

In all problem instances, the planner searches for a path from a starting position (8 m, 8 m) to a goal (88 m, 88 m). After a solution is found, the rover follows a designated path with u_{ref}=0.1 m/s while receiving edgewise noise slip sₑ. In a case in which sₑ≥1 (complete immobilization of the rover) and sₑ≤−1 (uncontrollability situation such as fall) are not observed, the solution is considered as a successful path.

The following four metrics quantify performance of the algorithm.
Solution rate (Sol.) [%] represents the percentage of problem instances for which the planner found a solution.
Success rate (success) [%] indicates the percentage of problem instances for which the found solution was successful.
Total time (Tₜₒₜₐₗ) [min] provides path efficiency by calculating a total traverse time along the path in a case in which traverse was successful.
Maximum slip (sₘₐₓ) [%] estimates safety of the path against interposition of the rover by calculating 100×max(sₑ) after path execution. Here, sₑ represents an experienced slip. A lower sₘₐₓ indicates that the rover can move on the terrain more safely.

In order to confirm effectiveness of the proposed approach, various passability prediction models and risk estimation indices were also estimated. For prediction, a single Gaussian process (SGP) approach is given by choosing a GP on a basis of on the classified terrain type, as described in [9]. In addition to VaR and CVaR, the expectation value (EV) quantifies the designated slip distribution for cost calculation. The metrics are combined, and a planning procedure is performed on the data set for comparison.

### <D. Results>

1) Quantitative Comparison: Table 1 summarizes performance of quantitative path planning for three data sets, and α=0.99 for VaR and CVaR. Throughout the data sets, the proposed approach has the highest performance in terms of safety to avoid immobilized situations, as indicated by the success rate and the maximum slip during path execution. As shown in the total time result, in a case of maintaining the speed of the rover, slip is also reduced, and this helps to maintain time efficiency. These results are suitable for planetary exploration in which safety is most important, as rover confinement results in a mission failure and overly-conservative rover navigation delays a mission schedule. Despite the higher appearance variety experienced in the ES data sets, erroneous slip modeling results in a decrease in relative performance of the planning results as compared to other data sets. It was found that planners using VaR and CVaR-based risk estimation do not provide a solution in some cases. This may occur when the goal position is in a dangerous area.

TABLE 1

| | | | |
|---|---|---|---|
| Sol. | Succ. | Tₜₒₜₐₗ | sₘₐₓ |

Standard (Std) Dataset

| | | | | | |
|---|---|---|---|---|---|
| SGP [9] | +EV | 100 | 71 | 22.6 ± 3.7 | 58.3 ± 47.0 |
| | +VaR | 100 | 74 | 22.6 ± 3.9 | 55.6 ± 45.4 |
| | +CVaR | 100 | 75 | 22.6 ± 3.9 | 55.3 ± 45.8 |
| MGP | +EV | 100 | 75 | 22.5 ± 3.5 | 56.1 ± 44.4 |
| | +VaR | 100 | 93 | 22.9 ± 4.4 | 47.5 ± 30.7 |

| | | | | |
|---|---|---|---|---|
| Ours (MGP + CVaR) | 100 | 96 | 23.2 ± 5.2 | 45.9 ± 24.2 |

Erroneous Slip (ES) Dataset

| | | | | | |
|---|---|---|---|---|---|
| SGP [9] | +EV | 100 | 60 | 23.0 ± 3.5 | 70.3 ± 40.7 |
| | +VaR | 98 | 65 | 24.3 ± 5.1 | 68.8 ± 44.7 |
| | +CVaR | 93 | 62 | 25.0 ± 5.7 | 67.9 ± 44.8 |
| MGP | +EV | 100 | 71 | 23.1 ± 4.4 | 68.2 ± 38.2 |
| | +VaR | 98 | 77 | 25.2 ± 12.7 | 63.1 ± 38.8 |

| | | | | |
|---|---|---|---|---|
| Ours (MGP + CVaR) | 90 | 77 | 27.2 ± 37.4 | 60.5 ± 37.1 |

Ambiguous Appearance (AA) Dataset

| | | | | | |
|---|---|---|---|---|---|
| SGP [9] | +EV | 100 | 11 | 22.1 ± 1.7 | 92.9 ± 27.4 |
| | +VaR | 100 | 7 | 24.8 ± 4.0 | 95.8 ± 19.3 |
| | +CVaR | 100 | 2 | 26.7 ± 1.8 | 96.3 ± 19.3 |
| MGP | +EV | 100 | 38 | 24.0 ± 5.6 | 81.4 ± 32.9 |
| | +VaR | 98 | 95 | 25.7 ± 5.3 | 64.5 ± 22.3 |

| | | | | |
|---|---|---|---|---|
| Ours (MGP + CVaR) | 96 | 95 | 26.4 ± 6.3 | 63.7 ± 21.6 |

As EV-based planners show, in a case of ignoring such a risk to prioritize finding a solution, the success rate is reduced. The MGP formulation for passability prediction significantly contributes to the success of the rover navigation. The most effective case is that the appearance of the terrain is provided by the AA data set which cannot guarantee the terrain class. In a case in which the MGPs are not used, traverse may fail due to a large prediction error caused by erroneous slip modeling because the passability prediction refers only to a representative slip model according to a specified terrain property. The algorithm proposed in the present disclosure solves this problem by integrating a plurality of GPs with terrain possibilities, and allows careful risk estimation considering tail events that are less likely to lead to an immobilized situation.

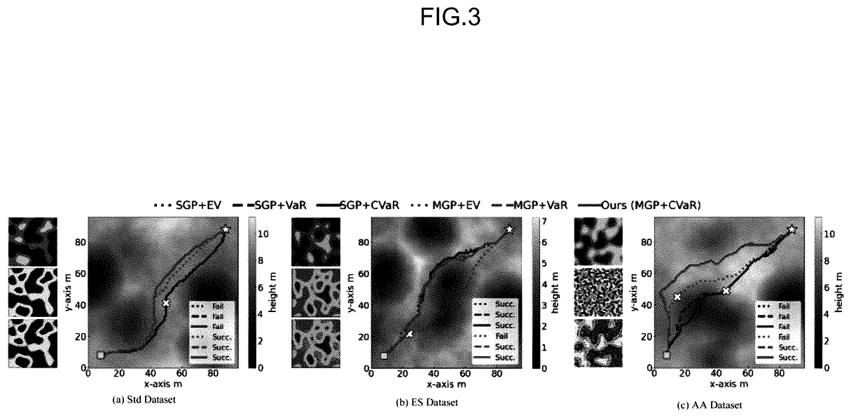

2) Qualitative Comparison: FIG. 3 shows a method in which planners with different risk metrics plan a path for problem instances from each data set. Although the MGP-based approach tends to find a trajectory along geometrically smooth regions as compared to the SGP-based approach, MGP+EV-based planners often find overly optimistic paths leading to rover immobilization, as shown in FIG. 3(b). This is because the MGP generates a slip distribution that covers a wider slip range as compared to a single GP. Thus, VaR and CVaR are necessary for a rational risk estimation to identify a ring slip that is less likely to occur in the MGP distribution, and enable successful rover traverse in challenging environments.

FIG. 3 shows results of path planning for different data sets. In an environment represented as a heat map, a green square and a yellow star are a start position and a target position. A white cross indicates a position where the rover cannot transition to the next state due to an experience of s=1. The input color, the ground-truth terrain class, and the terrain classification result are displayed from top to bottom on the left side of each heat map.

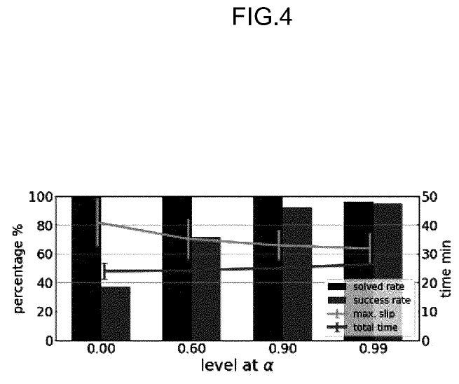

3) Parameter Investigation: Finally, an influence on the performance of the proposed algorithm is checked by performing parameter investigation to test α∈{0.00, 0.60, 0.90, 0.99} of the AA data set. FIG. 4 shows that a controls a tradeoff between safety and efficiency. As a is higher, the rover navigates a path with a less slip, and thus, the success rate is increased. As a is lower, more aggressive maneuvering can be performed, and thus, the traverse time can be shortened. Considering that a priority between safety and efficiency changes depending on a timeline of the mission, controllability of a planned operation through simple parameter adjustment is a beneficial aspect of the method of the present disclosure. In an initial search phase in which most terrain properties are unknown, safety may be desired to be prioritized.

4) Unsolved Problems and Possible Extensions: Although the algorithm proposed in the present disclosure can significantly improve safe traverse of celestial environments, there is no theoretical guarantee to avoid rover confinement. A possible extension complementarily utilizes probabilistic constraints, such as chance constraints, by formulating a rational interpretation of a fixed non-Boolean risk.

### VI. CONCLUSIONS

For reliable rover operation on a deformable terrain having a different type, a new path planning algorithm that can explicitly consider the uncertainty of ML-based passability prediction was presented. Through extensive simulation experiments, it was confirmed that the proposed algorithm was consistently superior to existing methods in terms of the success rate of planning and the maximum wheel slip experienced during path execution. In a future study, the feasibility of the proposed method in more various environments including an environment from the actual data will be investigated [5].

### First Embodiment

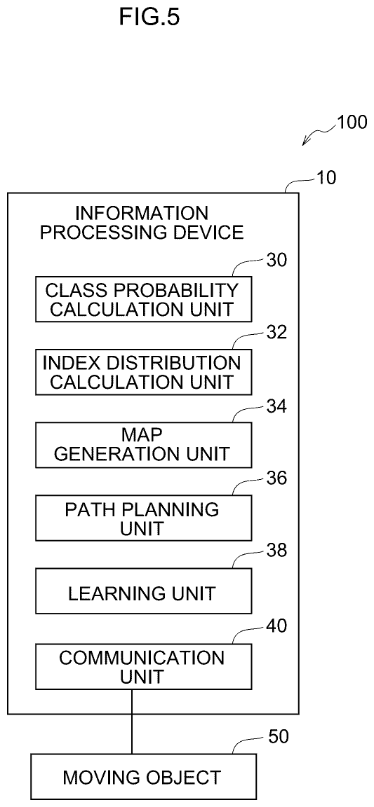

As illustrated in FIG. 5, an information processing system 100 according to the present embodiment includes an information processing device 10 and a moving object 50.

The moving object 50 is, for example, an automatic driving vehicle in automatic intersection management, an autonomous mobile robot (AMR) or an automatic guided vehicle (AGV) in a warehouse or a factory, a drone in an unmanned delivery system, or the like. The moving object 50 includes a movement mechanism for traveling, flying, and the like, a communication mechanism for performing communication with the information processing device 10, and a movement control mechanism for controlling the movement mechanism such that the moving object 50 moves according to a planned path.

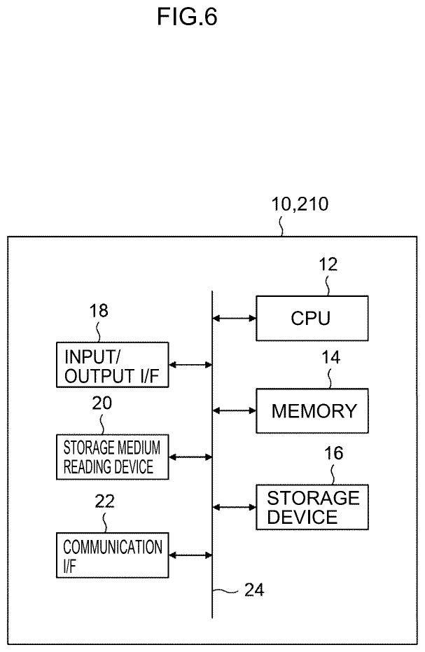

FIG. 6 is a block diagram illustrating a hardware configuration of the information processing device 10 according to a first embodiment. As illustrated in FIG. 5, the information processing device 10 includes a central processing unit (CPU) 12, a memory 14, a storage device 16, an input/output interface (I/F) 18, a storage medium reading device 20, and a communication I/F 22. The respective components are communicably connected to each other via a bus 24.

The storage device 16 stores an information processing program for executing pieces of processing to be described later. The CPU 12 is a central processing unit, and executes various programs and controls each component. That is, the CPU 12 reads the program from the storage device 16, and executes the program by using the memory 14 as a work area. The CPU 12 performs the above-described various types of arithmetic processing according to the program stored in the storage device 16.

The memory 14 includes a random access memory (RAM), and temporarily stores a program and data as a work area. The storage device 16 includes a read only memory (ROM), a hard disk drive (HDD), a solid state drive (SSD), and the like, and stores various programs including an operating system and various data.

The input/output I/F 18 is an interface that receives data from an external device and outputs data to the external device. Further, the input/output I/F 18 may be connected to, for example, input devices that receive various inputs, such as a keyboard and a mouse, and output devices that output various types of information, such as a display and a printer. In a case of adopting a touch panel display as the output device, the touch panel display may function as the input device.

The storage medium reading device 20 reads data stored in various storage media such as a compact disc (CD)-ROM, a digital versatile disc (DVD)-ROM, a Blu-ray disc, and a Universal Serial Bus (USB) memory, writes data in the storage medium, and the like.

The communication I/F 22 is an interface that performs communication with other devices, and for example, standards such as Ethernet (registered trademark), FDDI, and Wi-Fi (registered trademark) are used.

The information processing device 10 according to the present embodiment calculates, for each position of a target range, a probability distribution representing a probability of each class indicating a type of a region or a space from bird's-eye view data observed from a position at which the target range is overlooked, by using the above-described method. The information processing device 10 calculates, for each position of the target range, a probability distribution of an index on the basis of the probability distribution and the index indicating preference for each class as a movement region or a movement space, and plans a movement path of the moving object. Thereby, it is possible to estimate the index indicating preference for each position of the target range as a movement region or a movement space in consideration of errors in classification of the type of the region or the space, and it is possible to plan an appropriate movement path of the moving object.

As illustrated in FIG. 5, the information processing device 10 includes, as functional components, a class probability calculation unit 30, an index distribution calculation unit 32, a map generation unit 34, a path planning unit 36, a learning unit 38, and a communication unit 40. The functional components are implemented by causing the CPU 12 to read an information processing program stored in the storage device 16, develop the information processing program in the memory 14, and execute the information processing program.

The class probability calculation unit 30 calculates, for each position of the target range, a probability distribution representing a probability of each class indicating a type of a region or a space from bird's-eye view data observed from a position at which the target range is overlooked. Specifically, for each class c, classification likelihood Pᵥ(c) is calculated for each cell of a grid representing the target range by using a classification model that receives cells of bird's-eye view data as an input and outputs the classification likelihood of the class c. Here, the classification model is a neural network or a support vector machine (SVM) trained on the basis of correct answer data. Further, the bird's-eye view data is an image captured from a position at which the target range is overlooked, or sensor data sensed from a position at which the target range is overlooked.

The index distribution calculation unit 32 calculates, for each position of the target range, a probability distribution of an index on the basis of the probability distribution calculated by the class probability calculation unit 30 and the index indicating preference for each class as a movement region or a movement space.

Specifically, in a state where each cell of the grid representing the target range is set as a vertex, a probability distribution of a slip s, which is an index, is calculated for each edge between the vertices according to the expression (5). Here, the slip probability distribution Pₑ(s|c) of the class c is obtained in advance on the basis of past experimental data and past simulation results. The slip probability distribution Pₑ(s|c) of the class c is represented by using, for example, a Gaussian distribution. Note that a distribution other than the Gaussian distribution, for example, a non-parametric distribution such as a histogram may be used.

The map generation unit 34 generates a map representing the index at each position of the target range on the basis of the probability distribution of the index at each position of the target range.

Specifically, in a state where each cell of the grid representing the target range is set as a vertex, a scalar value of the slip s is calculated for each edge between the vertices from the probability distribution of the slip s by using the conditional value at risk (CVaR), and a map representing the scalar value of the slip s at each edge is generated.

The path planning unit 36 plans a movement path of the moving object on the basis of the map. Specifically, a movement path of the moving object 50 from a start point to a goal point is planned according to an existing algorithm (for example, A* algorithm, Dijkstra's algorithm).

Specifically, among edge sequences from the start point to the goal point, an edge sequence having the smallest sum of the scalar values of the slip s is planned as a movement path of the moving object 50 according to an existing algorithm (for example, A* algorithm, Dijkstra's algorithm).

Here, the moving object 50 is a vehicle, a robot, a character in a game, or a flying object.

The learning unit 38 trains the classification model on the basis of correct answer data. Here, the correct answer data is obtained by assigning a type of a region or a space to each position of the bird's-eye view data. The classification model is trained by using, as the correct answer data, a bird's-eye view data group obtained by assigning a type of a region or a space to each position.

The communication unit 40 notifies the moving object 50 of the movement path of the moving object 50 that is planned by the path planning unit 36.

### <Operation of Information Processing System>

Next, an operation of the information processing system 100 according to the present embodiment will be described.

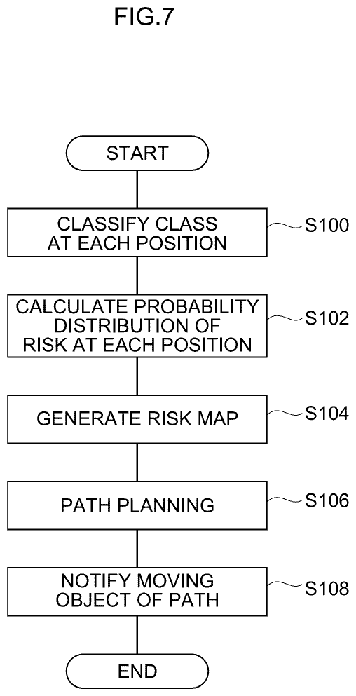

FIG. 7 is a flowchart illustrating a flow of path planning processing executed by the CPU 12 of the information processing device 10. The CPU 12 reads the information processing program from the storage device 16, develops the information processing program in the memory 14, and executes the information processing program. Thereby, the CPU 12 functions as the functional components of the information processing device 10, and the path planning processing illustrated in FIG. 7 is executed. At this time, it is assumed that bird's-eye view data observed from a position at which the target range is overlooked is input. In addition, it is assumed that the classification model is trained by the learning unit 38 on the basis of the correct answer data which is prepared in advance. Note that the path planning processing is an example of an information processing method.

In step S100, the class probability calculation unit 30 calculates, for each position of the target range, classification likelihood Pᵥ(c) as a probability distribution representing a probability of each class c indicating a type of a region or a space, by using the classification model, from the bird's-eye view data observed from a position at which the target range is overlooked.

In step S102, the index distribution calculation unit 32 calculates, for each position of the target range, a probability distribution of an index on the basis of the probability distribution calculated by the class probability calculation unit 30 and the index indicating preference for each class as a movement region or a movement space. Specifically, in a state where each cell of the grid representing the target range is set as a vertex, a probability distribution of a slip s, which is an index, is calculated for each edge between the vertices according to the expression (5).

In step S104, the map generation unit 34 generates a map representing the index at each position of the target range on the basis of the probability distribution of the index at each position of the target range. Specifically, in a state where each cell of the grid representing the target range is set as a vertex, a scalar value of a slip s is calculated for each edge between the vertices by the CVaR, and a map representing the scalar value of the slip s at each edge is generated.

In step S106, the path planning unit 36 plans a movement path of the moving object 50 on the basis of the map.

In step S108, the communication unit 40 notifies the moving object 50 of the movement path of the moving object 50 that is planned by the path planning unit 36, and ends the path planning processing.

Then, the moving object 50 moves along the movement path notified from the information processing device 10.

As described above, the information processing device 10 according to the first embodiment calculates, for each position of the target range, a probability distribution representing a probability of each class indicating a type of a region or a space from the bird's-eye view data observed from a position at which the target range is overlooked. The information processing device 10 calculates, for each position of the target range, a probability distribution of an index on the basis of the probability distribution and the index indicating preference of the moving object for each class as a movement region or a movement space. Thereby, it is possible to estimate a probability distribution of preference as a movement region or a movement space, the preference being an index for estimating a risk for each position of the target range, in consideration of errors in classification of a type of a region or a space.

### Second Embodiment

Next, an information processing system according to a second embodiment will be described. Note that parts having the same configurations as those of the first embodiment are denoted by the same reference numerals, and description thereof is omitted.

The second embodiment is different from the first embodiment in that a map is generated by using a certainty of a classification model.

### Outline of Second Embodiment

A neural network model called a prior network described in NPL 2 and a learning method of the neural network model are used. Information indicating a certainty of an inference result of a machine learning model related to terrain classification is also estimated and used in a form of “a certainty regarding that a probability of a terrain A is X % is Y %”. Thereby, it is possible to perform path planning in which a risk is estimated more safely, for example, “The probability of the terrain A is estimated to be 99%, but this is an estimation in a situation where data is insufficient, and the certainty is low. Therefore, the moving object is prevented from moving to this location at the time of path planning.”, “It can be said with confidence that a probability of this location being either a terrain A or a terrain B is 50%/50%. Therefore, the moving object is prevented from moving to this location during path planning.”, or the like.
NPL 2: “Regression prior network”, Internet search <URL: https://arxiv.org/abs/2006.11590>

In other words, as preference as a movement region, the preference being used for path planning and being an index for estimating a risk, “the certainty of the estimation result of the classification model as described above is further considered.

### <Configuration of Information Processing System>

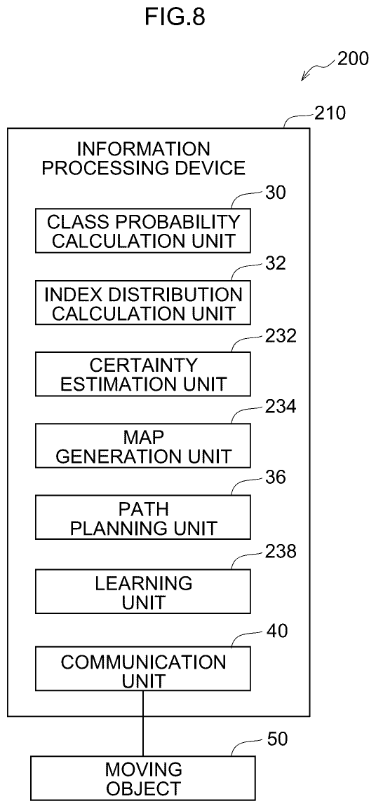

As illustrated in FIG. 8, an information processing system 200 according to the present embodiment includes an information processing device 210 and a moving object 50.

As illustrated in FIG. 6, the hardware configuration of the information processing device 210 according to the second embodiment is similar to the hardware configuration of the information processing device 10 according to the first embodiment.

As illustrated in FIG. 8, the information processing device 210 includes, functional components, a class probability calculation unit 30, an index distribution calculation unit 32, a certainty estimation unit 232, a map generation unit 234, a path planning unit 36, a learning unit 238, and a communication unit 40. The functional components are implemented by causing the CPU 12 to read an information processing program stored in the storage device 16, develop the information processing program in the memory 14, and execute the information processing program.

The certainty estimation unit 232 estimates, for each position of the target range, a certainty by using a certainty estimation model for estimating a certainty of classification by a classification model which classifies a class indicating a type of a region or a space from bird's-eye view data observed from a position at which the target range is overlooked.

Specifically, a model similar to the prior network described in NPL 2 is used. In a state where each cell of the grid representing the target range is set as a vertex, an uncertainty caused by knowledge and an uncertainty caused by data are estimated for each edge between the vertices from the classification likelihood Pᵥ(c) of each class that is output by the classification model. Here, the uncertainty caused by the knowledge is an uncertainty due to insufficiency of correct answer data used for training of the classification model. In addition, the uncertainty caused by data is an uncertainty due to data that has a difficulty in classification by a classification model.

The map generation unit 234 generates a map on the basis of the probability distribution of the index at each position of the target range and the certainty at each position of the target range.

Specifically, in a state where each cell of the grid representing the target range is set as a vertex, a cost f_{cost}(e: v→v′) that is related to a slip and is an index of the edge is calculated for each edge between the vertices according to the following expression, and a map representing the cost f_{cost}(e: v→v′) of each edge is generated. Here, the cost related to a slip is calculated to be higher as the certainty is lower.

$${f}_{cost} ( e : v \to {v}^{′} ) = g ( {s}_{pred} ( e ) , {u}_{model} ( e ) , {u}_{data} ( e ) )$$

Here, u_{model}(e) and u_{data}(e) are represented by the following expressions.

$$\begin{matrix}{u}_{model} ( e ) = {V}_{p ( u , Λ \vert x , θ )} [ μ ] ( e ) \\ {u}_{data} ( e ) = {E}_{p ( μΛ \vert x , θ )} [ {Λ}^{- 1} ] ( e )\end{matrix}$$

Note that the definitions of u_{model}(e) and u_{data}(e) are not limited to the expressions described above. u_{model}(e) and u_{data}(e) may be defined by expressions similar to the expression (5) of NPL 2. Further, the definition of g(s_{pred}(e), u_{model}(e), u_{data}(e)) may be explicitly given as follows, or may be implemented and trained by a neural network or the like.

As an example, the cost f_{cost}(e: v→v′) is represented by the following expression.

$${f}_{cost} ( e : v \to {v}^{′} ) = E [ {S}_{risk} ] ( e ) + \frac{α {u}_{model} ( e ) + β {u}_{data} ( e )}{\sqrt{{u}_{model} ( e ) + {u}_{data} ( e )}}$$

Here, ∈[Sᵣᵢₛₖ] (e) is an expected value of the random variable Sᵣᵢₛₖ(φ) in the expression (7) when φ is an inclination angle of an edge e, and the first term of the numerator of the second term on the right side is a product of the uncertainty caused by knowledge that is estimated using the certainty estimation model and a parameter u. The second term of the numerator of the second term on the right side is a product of the uncertainty caused by data that is estimated using the certainty estimation model and a parameter R. The denominator of the second term on the right side is the sum of the uncertainty caused by knowledge and the uncertainty caused by data that are estimated using the certainty estimation model. The parameters a and R are adjustable parameters for determining which uncertainty should be considered and how much the uncertainty should be considered when planning a path of the moving object 50.

As another example, the cost f_{cost}(e: v→v′) is represented by the following expression.

$${f}_{cost} ( e : v \to {v}^{′} ) = \frac{‖ x ( v ) - x ( {v}^{′} ) ‖}{{u}_{risk} ( e )}$$

$$Here , {u}_{risk} ( e ) uses the following expression in the expression of u ( e ) of the expression ( 6 ) .$$

$$S = E [ {S}_{risk} ] ( e ) + \frac{α {u}_{mo del} ( e ) + β {u}_{data} ( e )}{\sqrt{{u}_{model} ( e ) + {u}_{data} ( e )}}$$

As another example, the cost f_{cost}(e: v→v′) is represented by the following expression.

$${f}_{cost} ( e : v \to {v}^{′} ) = C - ( {c}_{pred} - {s}_{pred} ( e ) ) * ( {c}_{uncertain} - {s}_{uncertain} ( e ) )$$

Here, C, c_{pred}, and c_{uncertain} are appropriate constants such that the entire f_{cost}(e: v→v′) becomes a positive value. s_{uncertain}(e) is the second term on the right side of the expression.

The path planning unit 36 plans a movement path of the moving object on the basis of the map generated by the map generation unit 234.

Specifically, among edge sequences from the start point to the goal point, an edge sequence having the smallest sum of the costs related to the slip is planned as a movement path of the moving object 50 according to an existing algorithm (for example, A* algorithm, Dijkstra's algorithm).

The learning unit 238 trains the classification model on the basis of correct answer data. Here, the correct answer data is obtained by assigning a type of a region or a space to each position of the bird's-eye view data. The classification model is trained by using, as the correct answer data, a bird's-eye view data group obtained by assigning a type of a region or a space to each position.

In addition, the learning unit 238 trains the certainty estimation model by using the same data as the correct answer data used in training of the classification model. Specifically, a prior network is trained as the certainty estimation model from the same bird's-eye view data group as the correct answer data used for training of the classification model by using a method similar to the learning method described in NPL 2.

### <Operation of Information Processing System>

Next, an operation of the information processing system 200 according to the present embodiment will be described.

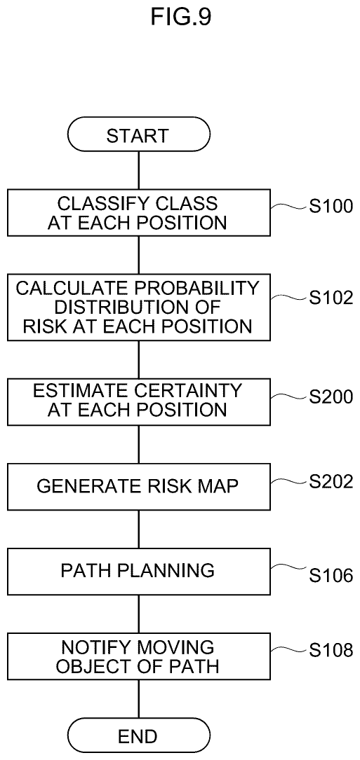

FIG. 9 is a flowchart illustrating a flow of path planning processing executed by the CPU 12 of the information processing device 210. The CPU 12 reads the information processing program from the storage device 16, develops the information processing program in the memory 14, and executes the information processing program. Thereby, the CPU 12 functions as the functional components of the information processing device 210, and the path planning processing illustrated in FIG. 9 is executed. At this time, it is assumed that bird's-eye view data observed from a position at which the target range is overlooked is input. In addition, it is assumed that the classification model and the certainty estimation model are trained by the learning unit 38 on the basis of the correct answer data which is prepared in advance. Note that the path planning processing is an example of an information processing method.

In step S100, the class probability calculation unit 30 calculates, for each position of the target range, classification likelihood Pᵥ(c) as a probability distribution representing a probability of each class c indicating a type of a region or a space, by using the classification model, from the bird's-eye view data observed from a position at which the target range is overlooked.

In step S102, the index distribution calculation unit 32 calculates, for each position of the target range, a probability distribution of an index on the basis of the probability distribution calculated by the class probability calculation unit 30 and the index indicating preference for each class as a movement region or a movement space. Specifically, in a state where each cell of the grid representing the target range is set as a vertex, a probability distribution of a slip s, which is an index, is calculated for each edge between the vertices according to the expression (5).

In step S200, the certainty estimation unit 232 estimates, for each position of the target range, a certainty by using the certainty estimation model from bird's-eye view data observed from a position at which the target range is overlooked. Specifically, a model similar to the prior network described in NPL 2 is used. In a state where each cell of the grid representing the target range is set as a vertex, an uncertainty caused by knowledge and an uncertainty caused by data are estimated for each edge between the vertices from the classification likelihood Pᵥ(c) of each class that is output by the classification model.

In step S202, the map generation unit 234 generates a map on the basis of the probability distribution of the index at each position of the target range and the certainty at each position of the target range. Specifically, in a state where each cell of the grid representing the target range is set as a vertex, a cost f_{cost}(e: v→v′) that is related to a slip and is an index of the edge is calculated for each edge between the vertices, and a map representing the cost f_{cost}(e: v→v′) of each edge is generated.

In step S106, the path planning unit 36 plans a movement path of the moving object 50 on the basis of the map.

In step S108, the communication unit 40 notifies the moving object 50 of the movement path of the moving object 50 that is planned by the path planning unit 36, and ends the path planning processing.

Then, the moving object 50 moves along the movement path notified from the information processing device 210.

As described above, the information processing device 210 according to the second embodiment estimates, for each position of the target range, a certainty by using the certainty estimation model for estimating a certainty of classification by a classification model which classifies a class indicating a type of a region or a space from bird's-eye view data observed from a position at which the target range is overlooked. The information processing device 210 generates a map representing an index indicating preference of the moving object for each position of the target range as a movement region or a movement space, on the basis of the certainty, and plans a movement path of the moving object. Thereby, it is possible to generate a map of preference as a movement region or a movement space and plan a movement path, the preference being an index for estimating a risk for each position of a target range, in consideration of a certainty of classification by a classification model which classifies a class indicating a type of a region or a space. In particular, in consideration of an environment in which classification of types is difficult or an environment in which learning data is insufficient, it is possible to estimate an index indicating preference for each position in the environment as a movement region or a movement space.

Note that, in the above embodiment, the case in which the likelihood of a slip is used as the index indicating preference as a movement region has been described as an example, but the present disclosure is not limited thereto. As the index indicating preference as a movement region, another index may be used. For example, an index indicating movement difficulty such as a degree of unevenness of a movement region, a degree of mud splashing, and a small amount of vibration at the time of cooking or transporting medicines may be used.

In addition, as the index indicating preference as a movement region, the certainty described in the second embodiment may be used.

In addition, the case in which the index indicating preference as a movement region is estimated from the bird's-eye view data has been described as an example, but the present disclosure is not limited thereto. For example, an index indicating preference as a movement region may be estimated from the bird's-eye view data and the inclination angle information. In this case, the inclination angle of each position in the movement direction may be obtained from height information of each position and the movement direction of the moving object.

For example, in a case in which the moving object is a vehicle, the vehicle may be an autonomous vehicle or a vehicle driven by a person. In the case of a vehicle driven by a person, an index indicating a difficulty in movement or an index indicating preference for a path may be displayed on a display of the car navigation system. In calculation of the index, not only the bird's-eye view data but also indexes such as an outside temperature, a state of a road surface, a weather condition, the number of other vehicles around the vehicle, the number of persons, vehicle equipment such as a type of tires, and the model year may be calculated by being included in the calculation.

In addition, for example, in a case in which the moving object is a drone, in calculation of the index, indexes such as a weather condition, a line-of-sight condition, a wind direction, and a wind speed condition may be calculated by being included in the calculation.

Further, for example, in a case in which the moving object is a character in a computer simulation or a game, likelihood of being targeted by an enemy may also be calculated as an index.

Further, in the embodiment described above, when using bird's-eye view data observed from a position at which the target range is overlooked (global planning), in a state where the target range is limited to a range around the moving object, the index may be calculated (local planning).

In addition, FIG. 10 to FIG. 16 are diagrams for explaining details of the present embodiment.

Further, various processors other than the CPU may execute the pieces of processing executed by causing the CPU to read software (program) in the above embodiment. Examples of the processor in this case include a programmable logic device (PLD) such as a field-programmable gate array (FPGA) in which a circuit configuration can be changed after manufacturing, a dedicated electric circuit such as an application specific integrated circuit (ASIC) that is a processor having a circuit configuration exclusively designed for executing specific processing, and the like. In addition, the pieces of processing may be executed by one processor of these various processors, or may be executed by a combination of two or more processors having the same type or different types (for example, a plurality of FPGAs, a combination of a CPU and an FPGA, and the like). Further, a hardware structure of these various processors is, more specifically, an electric circuit in which circuit elements such as semiconductor elements are combined.

Furthermore, in the above embodiment, the aspect in which each program is stored (installed) in the storage device in advance has been described, but the present disclosure is not limited thereto. The program may be provided by being stored in a storage medium such as a CD-ROM, a DVD-ROM, a Blu-ray disk, or a USB memory. In addition, the program may be downloaded from an external device via a network.

Hereinafter, Appendixes related to the present disclosure will be described.

### Appendix 1

An information processing device including:
a class probability calculation unit that calculates, for each position of a target range, a probability distribution representing a probability of each class indicating a type of a region or a space from bird's-eye view data observed from a position at which the target range is overlooked; and
an index distribution calculation unit that calculates, for each position of the target range, a probability distribution of an index on a basis of the probability distribution and the index indicating preference of a moving object for each class as a movement region or a movement space.

### Appendix 2

The information processing device according to Appendix 1, further including:
a map generation unit that generates a map representing the index at each position of the target range on a basis of the probability distribution of the index at each position of the target range; and
a path planning unit that plans a movement path of the moving object on a basis of the map.

### Appendix 3

An information processing device including:
a map generation unit that estimates, for each position of a target range, a certainty of classification by using a certainty estimation model for estimating the certainty of classification by a classification model which classifies a class indicating a type of a region or a space, from bird's-eye view data observed from a position at which the target range is overlooked, and generates a map representing an index indicating preference of a moving object for each position of the target range as a movement region or a movement space on a basis of the certainty; and
a path planning unit that plans a movement path of the moving object on a basis of the map.

### Appendix 4

The information processing device according to Appendix 3, further including:
a class probability calculation unit that calculates, for each position of the target range, from the bird's-eye view data, a probability distribution representing a probability of each class indicating a type of a region or a space; and
an index distribution calculation unit that calculates, for each position of the target range, a probability distribution of an index on a basis of the probability distribution and the index indicating preference of the moving object for each class as a movement region or a movement space, in which
the map generation unit generates the map on a basis of the probability distribution of the index at each position of the target range and the certainty at each position of the target range.

### Appendix 5

The information processing device according to any one of Appendixes 1 to 4, in which the moving object is a vehicle, a robot, a character in a game, or a flying object.

### Appendix 6

An information processing method causing a computer to execute a process including:
calculating, for each position of a target range, a probability distribution representing a probability of each class indicating a type of a region or a space from bird's-eye view data observed from a position at which the target range is overlooked; and
calculating, for each position of the target range, a probability distribution of an index on a basis of the probability distribution and the index indicating preference of a moving object for each class as a movement region or a movement space.

### Appendix 7

An information processing method causing a computer to execute a process including:
estimating, for each position of a target range, a certainty of classification by using a certainty estimation model for estimating the certainty of classification by a classification model which classifies a class indicating a type of a region or a space, from bird's-eye view data observed from a position at which the target range is overlooked, and generating a map representing an index indicating preference of a moving object for each position of the target range as a movement region or a movement space on a basis of the certainty; and
planning a movement path of the moving object on a basis of the map.

### Appendix 8

An information processing program causing a computer to function as:
a class probability calculation unit that calculates, for each position of a target range, a probability distribution representing a probability of each class indicating a type of a region or a space from bird's-eye view data observed from a position at which the target range is overlooked; and
an index distribution calculation unit that calculates, for each position of the target range, a probability distribution of an index on a basis of the probability distribution and the index indicating preference of a moving object for each class as a movement region or a movement space.

### Appendix 9

An information processing program causing a computer to function as:
a map generation unit that estimates, for each position of a target range, a certainty of classification by using a certainty estimation model for estimating the certainty of classification by a classification model which classifies a class indicating a type of a region or a space, from bird's-eye view data observed from a position at which the target range is overlooked, and generates a map representing an index indicating preference of a moving object for each position of the target range as a movement region or a movement space on a basis of the certainty; and
a path planning unit that plans a movement path of the moving object on a basis of the map.

### Appendix 10

An information processing device including:
a memory; and
at least one processor connected to the memory, in which
the processor is configured to: calculate, for each position of a target range, a probability distribution representing a probability of each class indicating a type of a region or a space from bird's-eye view data observed from a position at which the target range is overlooked; and
calculate, for each position of the target range, a probability distribution of an index on a basis of the probability distribution and the index indicating preference of a moving object for each class as a movement region or a movement space.

### Appendix 11

A non-transitory storage medium storing a program executable by a computer to execute information processing, the information processing including:
calculating, for each position of a target range, a probability distribution representing a probability of each class indicating a type of a region or a space from bird's-eye view data observed from a position at which the target range is overlooked; and
calculating, for each position of the target range, a probability distribution of an index on a basis of the probability distribution and the index indicating preference of a moving object for each class as a movement region or a movement space.

### Appendix 12

An information processing device including:
a memory; and
at least one processor connected to the memory, in which
the processor is configured to:
estimate, for each position of a target range, a certainty of classification by using a certainty estimation model for estimating the certainty of classification by a classification model which classifies a class indicating a type of a region or a space, from bird's-eye view data observed from a position at which the target range is overlooked, and generate a map representing an index indicating preference of a moving object for each position of the target range as a movement region or a movement space on a basis of the certainty; and
plan a movement path of the moving object on a basis of the map.

### Appendix 13

A non-transitory storage medium storing a program executable by a computer to execute path planning processing, the path planning processing including:
estimating, for each position of a target range, a certainty of classification by using a certainty estimation model for estimating the certainty of classification by a classification model which classifies a class indicating a type of a region or a space, from bird's-eye view data observed from a position at which the target range is overlooked, and generating a map representing an index indicating preference of a moving object for each position of the target range as a movement region or a movement space on a basis of the certainty; and
planning a movement path of the moving object on a basis of the map.

The disclosures of Japanese Patent Application No. 2023-088196 and Japanese Patent Application No. 2023-030489 are entirely incorporated herein by reference.

All documents, patent applications, and technical standards described in the specification are incorporated herein by reference to the same extent as if each individual document, patent application, and technical standard are specifically and individually described to be incorporated by reference.

1. An information processing device, comprising:
a class probability calculation unit that calculates, for each position of a target range, a probability distribution representing a probability of each class indicating a type of a region or a space, from bird's-eye view data observed from a position at which the target range is overlooked; and
an index distribution calculation unit that calculates, for each position of the target range, a probability distribution of an index based on the probability distribution and the index that indicates a preference of a moving object for each class as a movement region or a movement space.

2. The information processing device according to claim 1, further comprising:
a map generation unit that generates a map representing the index at each position of the target range based on the probability distribution of the index at each position of the target range; and
a path planning unit that plans a movement path of the moving object based on the map.

3. An information processing device, comprising:
a map generation unit that estimates, for each position of a target range, a certainty of classification by using a certainty estimation model for estimating the certainty of classification by a classification model that classifies a class indicating a type of a region or a space, from bird's-eye view data observed from a position at which the target range is overlooked, and generates a map representing an index indicating a preference of a moving object for each position of the target range as a movement region or a movement space, based on the certainty; and
a path planning unit that plans a movement path of the moving object based on the map.

4. The information processing device according to claim 3, further comprising:
a class probability calculation unit that calculates, for each position of the target range, from the bird's-eye view data, a probability distribution representing a probability of each class indicating a type of a region or a space; and
an index distribution calculation unit that calculates, for each position of the target range, a probability distribution of an index based on the probability distribution and the index that indicates a preference of the moving object for each class as a movement region or a movement space, wherein:
the map generation unit generates the map based on the probability distribution of the index at each position of the target range and the certainty at each position of the target range.

5. The information processing device according to any one of claims 1 to 4, wherein the moving object is a vehicle, a robot, a character in a game, or a flying object.

6. An information processing method that causes a computer to execute processing comprising:
calculating, for each position of a target range, a probability distribution representing a probability of each class indicating a type of a region or a space, from bird's-eye view data observed from a position at which the target range is overlooked; and
calculating, for each position of the target range, a probability distribution of an index based on the probability distribution and the index that indicates a preference of a moving object for each class as a movement region or a movement space.

7. An information processing method that causes a computer to execute processing comprising:
estimating, for each position of a target range, a certainty of classification by using a certainty estimation model for estimating the certainty of classification by a classification model that classifies a class indicating a type of a region or a space, from bird's-eye view data observed from a position at which the target range is overlooked, and generating a map representing an index indicating a preference of a moving object for each position of the target range as a movement region or a movement space, based on the certainty; and
planning a movement path of the moving object based on the map.

8. An information processing program that causes a computer to function as:
a class probability calculation unit that calculates, for each position of a target range, a probability distribution representing a probability of each class indicating a type of a region or a space, from bird's-eye view data observed from a position at which the target range is overlooked; and
an index distribution calculation unit that calculates, for each position of the target range, a probability distribution of an index based on the probability distribution and the index that indicates a preference of a moving object for each class as a movement region or a movement space.

9. An information processing program that causes a computer to function as:
a map generation unit that estimates, for each position of a target range, a certainty of classification by using a certainty estimation model for estimating the certainty of classification by a classification model that classifies a class indicating a type of a region or a space, from bird's-eye view data observed from a position at which the target range is overlooked, and generates a map representing an index indicating a preference of a moving object for each position of the target range as a movement region or a movement space, based on the certainty; and
a path planning unit that plans a movement path of the moving object based on the map.
